(19) United States
(12) Patent Application Publication
(10) Pub. No.: US 2021/0089163 A1
(43) Pub. Date: Mar. 25, 2021

(54) TOUCH DEVICE AND OPERATION METHOD THEREOF

(71) Applicant: ELAN MICROELECTRONICS CORPORATION, Hsinchu (TW)

(72) Inventors: Hsueh-Wei YANG, Zhubei City (TW); Ting-Jan YANG, Jincheng Township (TW); Sung-Lin Wang, Taichung City (TW)

(73) Assignee: ELAN MICROELECTRONICS CORPORATION, Hsinchu (TW)

(21) Appl. No.: 16/932,246

(22) Filed: Jul. 17, 2020

(30) Foreign Application Priority Data
Sep. 19, 2019 (TW) 108133883

(51) Int. Cl. G06F 3/041; G06F 3/01

(52) U.S. Cl. CPC G06F 3/0418; G06F 2203/04106; G06F 3/016

(57) ABSTRACT

A touch device and an operation method thereof is provided. By determining whether the operating event of the touch device or its touchpad satisfies an exclusion condition, the command triggered when the touchpad is pressed is determined to be ignored or not. Therefore, the corresponding command triggered by pressing the touchpad downward is automatically excluded when it does not want to be triggered. Therefore, the user can naturally disable the function of the corresponding command, which is executed when the pressing module is triggered, during use without using other controls, thereby improving the convenience of use.

### CROSS-REFERENCE TO RELATED APPLICATIONS

This application is based upon and claims priority under 35 U.S.C. 119 from Taiwan Patent Application No. 108133883 filed on Sep. 19, 2019, which is hereby specifically incorporated herein by this reference thereto.

### BACKGROUND OF THE INVENTION

### 1. Field of the Invention

The present invention relates to a touch device, especially to a touch device applied to a portable electronic device.

### 2. Description of the Prior Arts

The conventional notebook computers usually have touchpads for the user to use as an input device. When the notebook computer does not connect to a mouse, the user's finger could move on the touchpad to control the cursor on the screen and to control the corresponding functions of the specific applications. Besides moving the cursor, the touchpad also has a pressing module to correspond to the left and right buttons of the mouse. When the user presses the touchpad with a preset force, the pressing module is triggered to provide the corresponding function of the left or right buttons of the mouse.

However, the user does not always need the functions of the pressing module when using the touchpad. For example, when the user's fingers move on the touchpad or when the user puts the hand on the touchpad, the user may inadvertently apply enough force to trigger the pressing module. Since the user does not need the functions of the pressing module at this time, a lot of troubles are caused to the use process when the function of the pressing module is triggered by improper force.

### SUMMARY OF THE INVENTION

To overcome the shortcomings, the present invention provides a touch device and an operation method thereof to mitigate or to obviate the aforementioned problems.

The present invention provides an operation method of a touch device, which has a touchpad, comprising steps of: (a) determining whether an event occurred on the touch device or the touchpad satisfies an exclusion condition; and (b) when the event occurred on the touch device or the touchpad satisfies an exclusion condition, ignoring a command triggered by pressing downward the touchpad.

The present invention also provides a touch device for executing foregoing operation method. The touch device comprises a host; and a touchpad electrically connecting to the host and comprising a touch operation surface; multiple electrode units disposed under the touch operation surface; and a control unit electrically connecting to the electrode units and the host.

The advantage of the present invention is that by detecting the exclusion condition determines whether the user needs the touchpad to provide the function corresponding to the left and right buttons of a mouse. When the exclusion condition is satisfied, the touchpad does not execute the command that triggered by pressing downward the touchpad. The user can unknowingly execute the triggering function when needed. In this way, it is close to the habits of users to increase the convenience of use.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a first embodiment of a touch device in accordance with the present invention;

FIG. 2 is a block diagram of a second embodiment of a touch device in accordance with the present invention;

FIG. 3 is a perspective view of some components of the touch device in

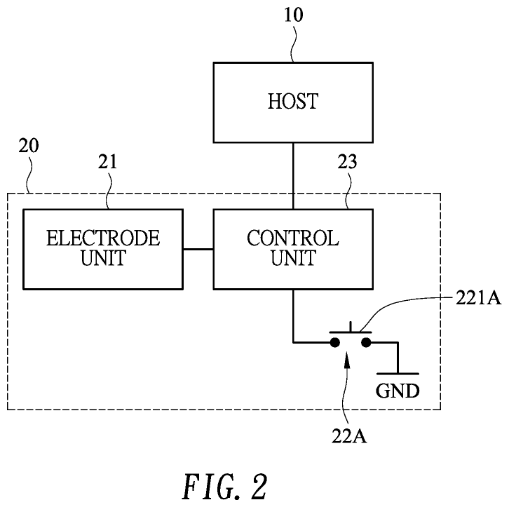

FIG. 2;

FIG. 4 is an operational perspective view of some components of the touch device in FIG. 2;

FIG. 5 is a block diagram of a third embodiment of a touch device in accordance with the present invention;

FIG. 6 is a perspective view of some components of the touch device in

FIG. 5;

FIG. 7 is an operational perspective view of some components of the touch device in FIG. 5;

FIG. 8 is a flow chart of a first embodiment of an operation method in accordance with the present invention;

FIG. 9 is a flow chart of a second embodiment of an operation method in accordance with the present invention;

FIG. 10 is a flow chart of a third embodiment of an operation method in accordance with the present invention;

FIG. 11 is a flow chart of a fourth embodiment of an operation method in accordance with the present invention; and

FIG. 12 is a flow chart of a fifth embodiment of an operation method in accordance with the present invention.

### DETAILED DESCRIPTION OF THE EMBODIMENTS

With reference to the attached drawings, the present invention is described by means of the embodiment(s) below where the attached drawings are simplified for illustration purposes only to illustrate the structures or methods of the present invention by describing the relationships between the components and assembly in the present invention. Therefore, the components shown in the figures are not expressed with the actual numbers, actual shapes, actual dimensions, nor with the actual ratio. Some of the dimensions or dimension ratios have been enlarged or simplified to provide a better illustration. The actual numbers, actual shapes, or actual dimension ratios can be selectively designed and disposed and the detail component layouts may be more complicated.

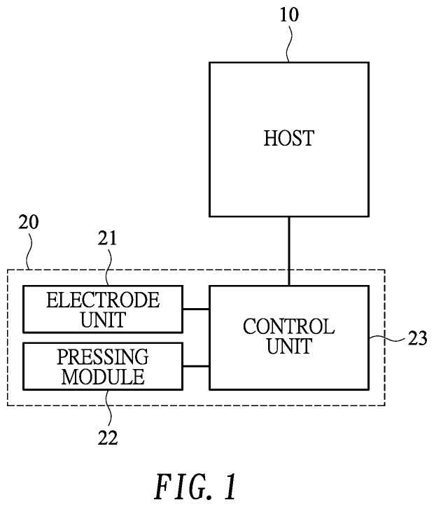

With reference to FIG. 1, the touch device comprises a host 10 and a touchpad 20. The touchpad includes a touch operation surface, multiple electrode units 21, a pressing module 22 and a control unit 23. The electrode units 21 and the pressing module 22 are disposed under the touch operation surface. The control unit 23 electrically connects to the electrode units 21 and the pressing module 22 respectively, and also electrically connects to the host 10. When an object moves on the touch operation surface, the electrode units 21 detect a sensing signal corresponding to the object and transmit the sensing signal to the control unit 23. The control unit 23 then transmits the sensing signal to the host 10 to determine the position, moving track, moving speed and corresponding triggered function triggered by the object. When the object presses downward on the touch operation surface and triggers the pressing module 22, the pressing module 22 transmits a triggered signal to the control unit 23. The control unit 23 then transmits the triggered signal to the host 10 to execute the corresponding triggered function when the pressing module 22 is triggered. The touch device in accordance with the present invention has following embodiments, but is not limited thereto.

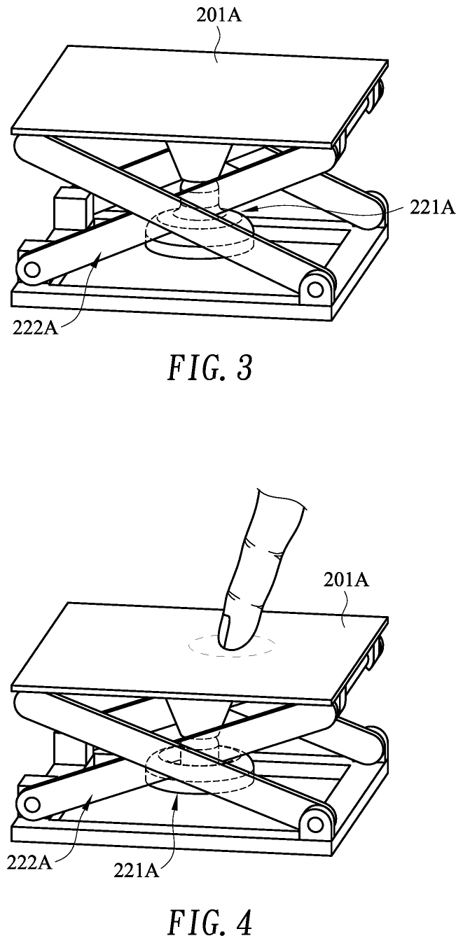

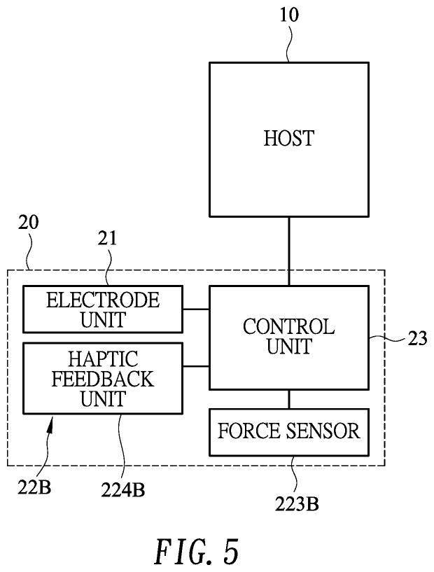

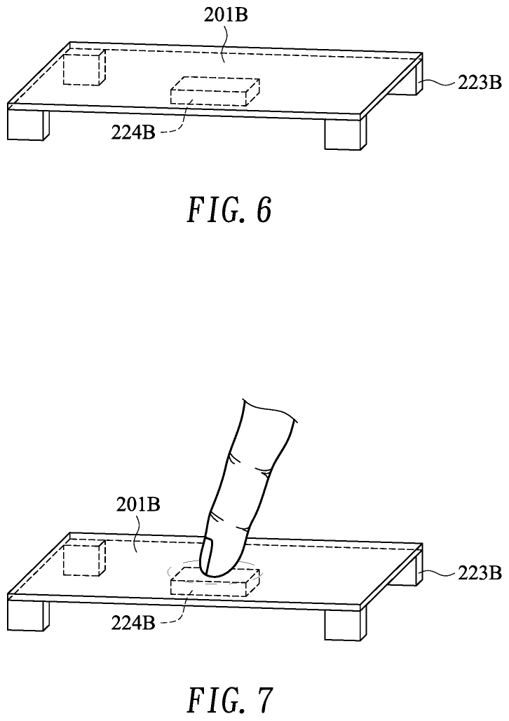

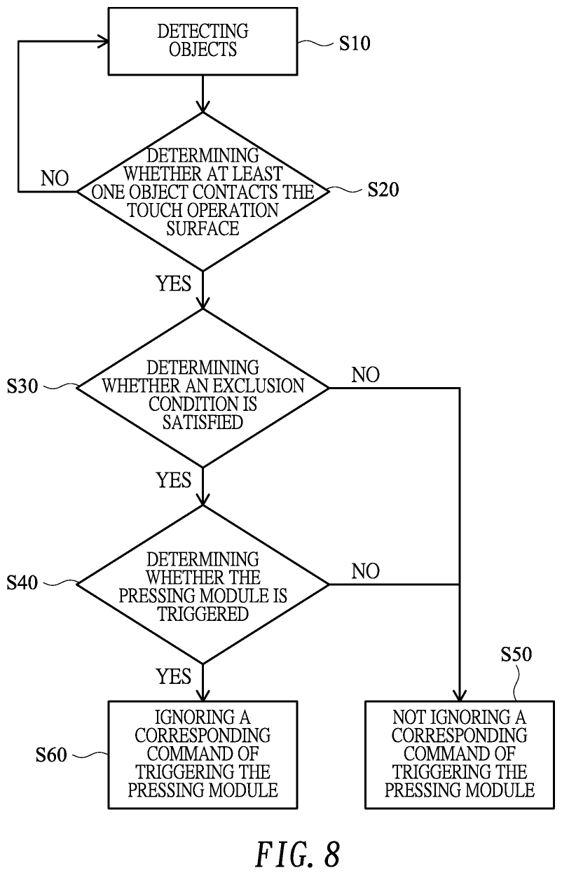

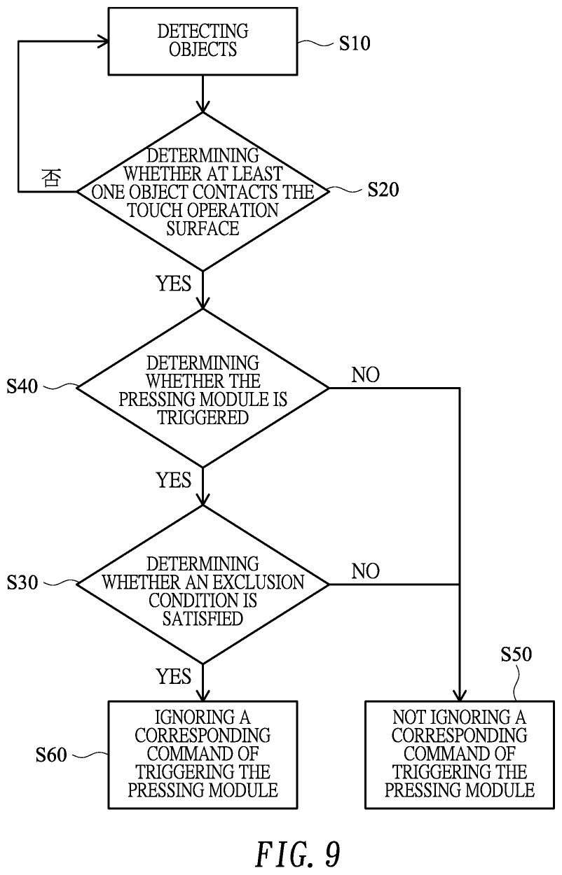

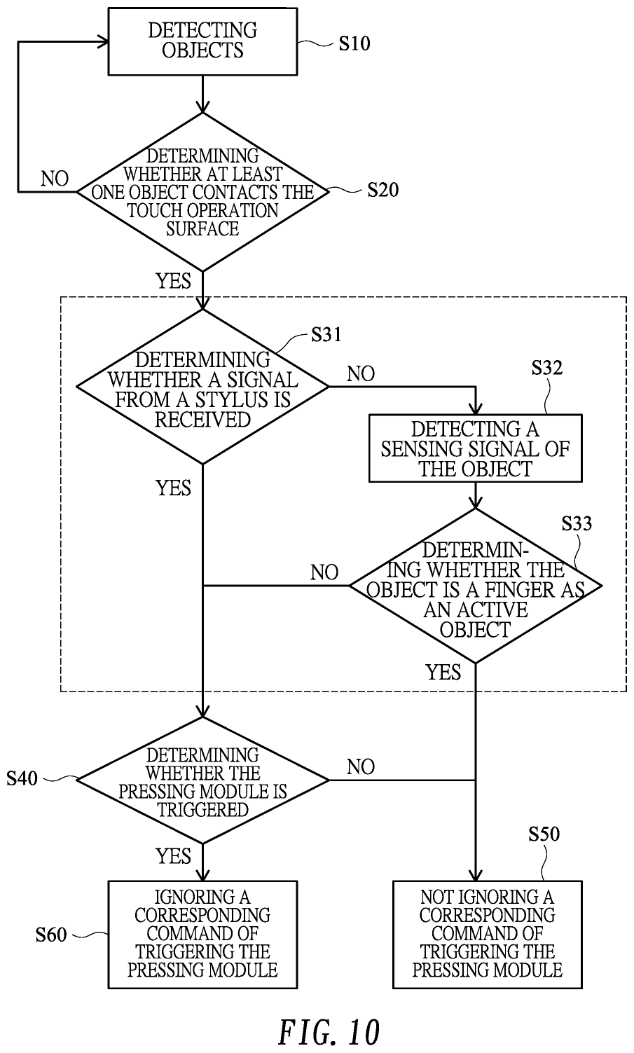

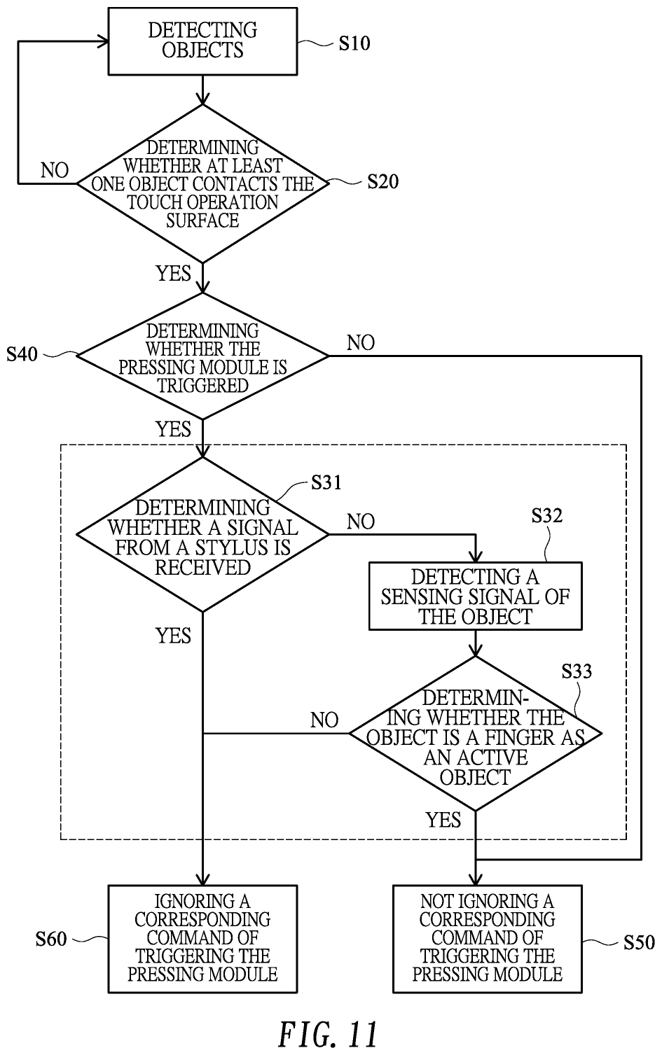

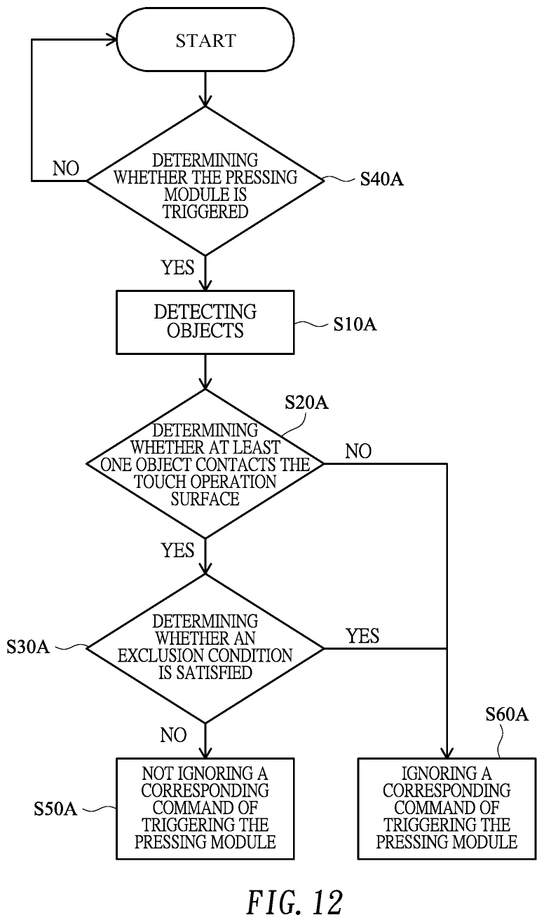

With reference to FIGS. 2 and 3, in one embodiment, the pressing module 22A comprises a switch 221A and a reposition mechanism 222A. The switch 221A and the reposition mechanism 222A are disposed under the touch operation surface 201A. With reference to FIG. 4, when the user presses downward on the touch operation surface 201A, the reposition mechanism 222A is pressed downward to press and to turn on the switch 221A simultaneously. Thus, the pressing module 22A is triggered. With reference to FIG. 3, when the user releases the force, the reposition assembly 222A has no external force to press thereon. Therefore, the reposition assembly 222A pushes the touch operation surface 201A to move back to the original position, and the switch 221A is turned off. The reposition mechanism 222A may comprise a linkage and a spring, but is not limited thereto.

With reference to FIGS. 5 and 6, in another embodiment, the pressing module 22B of the touchpad 20B comprises at least one force sensor 223B and a haptic feedback unit 224B. In this embodiment, the pressing module 22B has four force sensors 223B. The force sensors 223B are disposed separately under the touch operation surface 201B, such as disposed at four corners. The haptic feedback unit 224B is disposed under the touch operation surface 201B. The haptic feedback unit 224B may be a linear motor or a piezoelectric-actuating element. With reference to FIG. 7, when the user presses downward on the touch operation surface 201B, the force sensors 223B transmit the detected force information to the control unit 23. Then the control unit 23 transmits the detected force information to the host 10 to determine whether the downward force of the user exceeds a threshold. If the downward force of the user exceeds the threshold, the pressing module 22B is determined to be triggered. Thus, the haptic feedback unit 224B is actuated to vibrate. The user can feel the vibration through the touch operation surface 201B to know that the pressing module 22B is triggered.

The operation method in accordance with the present invention is mainly to first determine whether an operation event occurred on the touch device satisfies an exclusion condition. If the operation event occurred on the touch device satisfies the exclusion condition, the command triggered by pressing downward the touchpad is ignored. Following descriptions are different embodiments of the operation method in accordance with the present invention, but the present invention is not limited thereto.

With reference to FIGS. 1 and 8, the operation method in accordance with the present invention comprises following steps S10 to S50, which are recited comprehensively as follows.

Detecting objects (S10): The objects on the touch operation surface of the touchpad 20 are detected through the electrode units 21.

Determining whether at least one object contacts the touch operation surface (S20): When the object contacts the touch operation surface, the electrode units 21 detect the sensing signal corresponding to the object. Then, the control unit 23 or the host 10 further determines the object contacts the touch operation surface and executes a next step S30. When no object contacts the touch operation surface, the step S10 is then executed again for continually detection. For example, if the object is a stylus, the electrode units 21 receive the signal from the stylus. If the object is a finger or a palm, the electrode units 21 corresponding to the contacted area of the finger or the palm have different sensing capacitances.

Determining whether an exclusion condition is satisfied (S30): When the object is determined as contacting the touch operation surface, the control unit 23 or the host 10 further determines whether at least one of the operating system of the host 10, the object itself and the event triggered by the object satisfies the exclusion condition.

In one embodiment, to determine the operating system of the host 10 satisfying the exclusion condition means that the host 10 activates a specific application, or that the specific application is activated and a cursor position controlled by the object is located in a first area of the window opened by the specific application. Thus, to satisfy the exclusion condition means that the operation by user does not intend to trigger the pressing module 22. For example, when a drawing application is activated, all operations of the objects by user on the touch operation surface are likely to be drawing behaviors. At this time, the change of the downward pressure by the object should correspond to the thickness of the drawing line that the stylus wants to demonstrate, rather than triggering the pressing module 22. Thus, when the drawing application is activated, the operating system of the host 10 should be considered as satisfying the exclusion condition. Otherwise, the drawing application may have a drawing area and a peripheral command area. When the drawing application is activated, the behaviors of the object in the drawing area are likely to be drawing behaviors while the behaviors of the object in the command area could still try to trigger the pressing module 22. Therefore, when activating the drawing application and the cursor controlled by the object locating in the drawing area are determined as that the host 10 satisfies the exclusion condition.

In another embodiment, to determine the object itself satisfying the exclusion condition means that the object is not a pressing-triggering object, such as a stylus, a palm or a finger that is determined as the non-active object. The stylus as mentioned above is mostly a drawing tool, and the palm or finger determined as non-active object has a greater chance of accidental touch and to trigger the pressing module 22. Thus, the stylus, the palm and the finger determined as the non-active object are not determined as the pressing-triggering objects. On the other hand, the finger determined as an active object is marked as the pressing-triggering object so that the finger determined as the active object does not satisfy the exclusion condition. The aforementioned determination of the exclusion condition can be performed by the firmware of the control unit 23 or the operating system of the host 10. The method of determining objects can be the following various implementation methods, but not limited thereto. The present invention may include the following respective implementation methods alone, or may include multiple implementation methods at the same time.

In one implementation method, when the object contacts the touch operation surface, the electrode units 21 generate a touch sensing group and a hover sensing group located outside the touch sensing group. The object is determined as a finger or a palm according to whether the hove sensing group matches preset characteristics. For example, when the range of the hover sensing group is small or the width thereof is narrow, the object is determined as a finger. When the range of the hover sensing group is large or the width thereof is wide, the object is determined as the palm.

In another implementation method, when the object contacts the touch operation surface, the electrode units 21 generate a peak sensing value and multiple surrounding sensing values adjacent to the peak sensing value. Then, the variation between the peak sensing value and the surrounding sensing value is calculated. If the variation is greater than a preset value, the object is determined as a stylus. If the variation is less than the preset value, the object is determined as a finger. For example, if the difference between the peak sensing value and the surrounding sensing value is greater than the preset value, the object is determined as the stylus. If the difference between the peak sensing value and the surrounding sensing value is less than the preset value, the object is determined as a finger. For another example, if the ratio between the peak sensing value and the surrounding sensing value is greater than the preset value, the object is determined as the stylus. If the ratio between the peak sensing value and the surrounding sensing value is less than the preset value, the object is determined as the finger.

In another implementation method, when the object contacts the touch operation surface, the electrode units 21 generate a peak sensing value and multiple surrounding sensing values adjacent to the peak sensing value. The sum of the peak sensing value and the surrounding sensing value is calculated. If the sum of the peak sensing value and the surrounding sensing value is greater than a preset value, the object is determined as the finger. If the sum of the peak sensing value and the surrounding sensing value is less than the preset value, the object is determined as the stylus.

In another implementation method, when the object contacts the touch operation surface, the object is first determined as a non-active object. When the object satisfies an actuating condition, the status of the object is changed to be an active object. For example, when the moving distance of the object is greater than a distance threshold, the status of the object is changed from the non-active object to the active object.

In another implementation method, when the object contacts the touch operation surface, the object is first determined as an active object. When the detention time of the object exceeds a preset time, the status of the object is changed from the active object to the non-active object.

In another implementation method, after the object is determined as finger, palm or stylus, according to the mode or application activated by the host 10 at that time, the objects are determined that should be marked as active or non-active objects based on their types. For example, when the host 10 activates a handwriting application, the stylus is determined as the active object, and the finger or the palm is determined as the non-active object.

If the aforementioned step S30 determines that the object itself satisfies the exclusion condition, the amount of the objects is also a determination parameter besides the aforementioned methods. For example, the exclusion condition may simply to be satisfied by determining the amount of the objects on the touch operation surface. For instance, if the amount of the objects exceeds a first preset amount threshold, such as two, the exclusion condition is satisfied. On the other hand, the exclusion condition may include both the determination of the active and non-active objects and the amount of the objects. For instance, a second preset amount threshold, such as one, is used as a amount threshold of the active object. The exclusion condition is satisfied when the amount of the active objects is larger than or equal to the second preset amount threshold. For example, if the amount of the active objects is equal to one, the amount of the non-active objects is not considerable and the exclusion condition is not satisfied. Otherwise, if the amount of the active objects is equal to two, the exclusion condition is satisfied.

Furthermore, if in the aforementioned step S30 determines that the event triggered by the object satisfies the exclusion condition, the exclusion condition is satisfied when the event triggered by the object is recognized as a specific gesture. For example, the event triggered by the object is recognized as a gesture of two-finger scrolling. Since the user has the opportunity to apply force unintentionally during the process of using the two-finger scrolling gesture, the corresponding command, which is executed when the pressing module is triggered, is executed inadvertently. However, when the user constitutes the gesture of two-finger scrolling, the user has low chance to trigger the pressing module intentionally. Thus, the condition may be set as that the exclusion condition is satisfied when the gesture of two-finger scrolling is recognized. The triggered event is not limited to the two-finger scrolling and may be other different gestures.

Determining whether the pressing module 22 is triggered (S40): When an object is detected to contact the touch operation surface, the contact of the object on the touch operation surface is determined whether triggers the pressing module 22. It means that to determine whether the press of the object on the touch operation surface satisfies the condition to trigger the pressing module 22. As to the embodiment shown in FIGS. 2 to 4, when the switch 221 is pressed down to be turned on, the pressing module 22A is triggered. As to the embodiment shown in FIGS. 5 to 7, when the downward force of the objects determined by the force information detected by the force sensors 223B exceeds the threshold, the pressing module 22B is triggered.

Not ignoring the corresponding command, which is executed when the pressing module 22 is triggered, when the exclusion condition is not satisfied in the step S30 (S50): When the exclusion condition is not satisfied in the step S30 and the pressing module 22 is triggered, the host 10 executes the corresponding command, which is executed when the pressing module 22 is triggered, such as actuating the left or right buttons, click, select and so on. If in the steps S30 and S40, the exclusion condition is satisfied and the pressing module 22 is triggered, the corresponding command, which is executed when the pressing module 22 is triggered, is ignored so that the corresponding command of triggering the pressing module 22 is not executed.

With reference to FIGS. 8 and 9, the sequence of the steps S30 and the S40 may be altered and the alteration does not affect the execution of the operation method in accordance with the present invention.

With reference to FIG. 10, the step S30 may further comprise following steps:

Determining whether a signal from a stylus is received when an object hovers or contacts on the touch operation surface (S31): If the signal from the stylus is received at this time, it is regarded as satisfying the exclusion condition. When the user uses the stylus as an object for touch operation, most of them are drawing behaviors. As mentioned above, it does not want to trigger the pressing module 22. Therefore, when the signal of the stylus is received, it is considered that the object is a stylus, and the exclusion condition is satisfied.

Detecting the sensing signals of the object continually when no signal from the stylus is received (S32), and further determining whether the object is a finger as an active object (S33): When the object is determined as a finger of an active object, the exclusion condition is not satisfied and the corresponding command, which is executed when the pressing module 22 is triggered, is not ignored. If the pressing module 22 is triggered, the corresponding command of the pressing module 22 is still activated. However, when the object is determined as a finger of a non-active object, the corresponding command, which is executed when the pressing module 22 is triggered, is ignored even if the pressing module 22 is triggered.

With reference to FIGS. 10 and 11, the step S40 may be executed after the steps S31 and S33, or may be executed before the step S31.

With reference to FIGS. 1 and 12, another embodiment of the operation method in accordance with the present invention comprises following steps: First, the pressing module 22 is determined whether is triggered (S40A). If so, an object is further detected (S10A) to determine whether at least one object contacts the touch operation surface (S20A). If so, an exclusion condition is further determined whether is satisfied (S30A). If no object is determined to contact the touch operation surface in the step S20A, then the corresponding command, which is executed when the pressing module 22 is triggered, is ignored (S60A). If an exclusion condition is determined as being satisfied in the step S30A, the corresponding command, which is executed when the pressing module 22 is triggered, is also ignored (S60A). Otherwise, if the exclusion condition is determined as not being satisfied, the corresponding command, which is executed when the pressing module 22 is triggered, is not ignored (S50A). The detailed execution details of each step are as described above, so the details are repeated here. This embodiment is mainly directed to whether the object can be detected by the electrode units 21 of the touchpad 20, and whether the pressing module 22 is triggered is used as the initial determination directly. Thus, the non-conducting object from falsely triggering the pressing command is effectively prevented.

Thus, with setting the exclusion condition, the present invention determines whether the corresponding command, which is executed when the pressing module 22 is triggered, is ignored. Then for the most of the situations that the pressing module 22 does not need to be triggered, it is still possible to automatically ignore the execution of the corresponding command, which is executed when the pressing module 22 is triggered, through the internal function even if the pressing module 22 is accidentally triggered. Then the user can naturally eliminate the inconvenience caused by erroneously actuating the pressing module 22 without performing additional actions, and the convenience in use can be improved.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An operation method of a touch device, which has a touchpad, comprising steps of:
(a) determining whether an event occurred on the touch device or the touchpad satisfies an exclusion condition; and
(b) when the event occurred on the touch device or the touchpad satisfies the exclusion condition, ignoring a command triggered by pressing downward the touchpad.

2. The operation method as claimed in claim 1, wherein in the step (a), determining whether the event occurred on the touch device or the touchpad satisfies the exclusion condition includes a step of detecting at least one object contacting the touchpad, and determining whether at least one of an operating system of a host corresponding to the touchpad, the at least one object and the event triggered by the at least one object satisfies the exclusion condition when the at least one object contacts the touchpad.

3. The operation method as claimed in claim 2, wherein the touchpad comprises a pressing module, and the operation method further comprising a step of:
determining whether the pressing module is triggered is executed, and executing the step (a) when the pressing module is triggered.

4. The operation method as claimed in claim 2, wherein in the step (a) includes a step of determining that the at least one object is a pressing-triggering object or a non-pressing-triggering object, and when the at least one object is determined as the non-pressing-triggering object, the exclusion condition is satisfied.

5. The operation method as claimed in claim 4, wherein the at least one object is determined as the pressing-triggering object when the at least one object is determined as a finger.

6. The operation method as claimed in claim 4, wherein the at least one object is determined as the non-pressing-triggering object when the at least one object is determined as a stylus or a palm.

7. The operation method as claimed in claim 4, wherein the step (a) includes steps of:
(a11) determining whether a signal from an active stylus is received;
(a12) determining the exclusion condition is satisfied when the signal from the active stylus is determined as being received in the step a11;
(a13) detecting a sensing signal of the at least one object when the signal from the active stylus is determined as not being received in the step a11, and determining whether the at least one object is a finger according to the sensing signal of the at least one object; and
(a14) determining the exclusion condition is satisfied when the at least one object is determined as not being a finger in the step a13.

8. The operation method as claimed in claim 2, wherein the exclusion condition is satisfied when an amount of the at least one object is larger than a first preset value.

9. The operation method as claimed in claim 2, wherein the exclusion condition is satisfied when the at least one object is determined as an active object and an amount of the at least one object is larger than a second preset value.

10. The operation method as claimed in claim 2, wherein the exclusion condition is satisfied when the event triggered by the object is recognized as a specific gesture.

11. The operation method as claimed in claim 2, wherein the exclusion condition is satisfied when a specific application of the operating system of the host corresponding to the touchpad is activated.

12. The operation method as claimed in claim 2, wherein in the step (a) includes a step of determining whether a specific application of the operating system of the host corresponding to the touchpad is activated; and when the specific application of the operating system of the host corresponding to the touchpad is activated, a step of determining whether a position of a cursor controlled by the at least one object is located in a first area in a window of the specific application is further executed; and the exclusion condition is satisfied when the cursor controlled by the at least one object is located in the first area in the window of the specific application.

13. The operation method as claimed in claim 3, wherein the pressing module of the touchpad includes a switch disposed under a touch operation surface of the touchpad, and determining whether the pressing module is triggered includes a step of determining whether the switch is pressed downward, and the pressing module is triggered when the switch is pressed downward.

14. The operation method as claimed in claim 3, wherein the pressing module of the touchpad includes at least one force sensor and a haptic feedback unit disposed under a touch operation surface of the touchpad, and determining whether the pressing module is triggered includes a step of determining whether a downward force is larger than a threshold, wherein the downward force is determined by a force information detected by the at least one force sensor, and the pressing module is triggered when the downward force is larger than the threshold, and the haptic feedback unit is activated when the pressing module is triggered and the event does not satisfy the exclusion condition.

15. A touch device comprising:
a host; and
a touchpad electrically connecting to the host and comprising
a touch operation surface;
multiple electrode units disposed under the touch operation surface; and
a control unit electrically connecting to the electrode units and the host, wherein
the touch device executes steps of:
(a) determining whether an event occurred on the touch device or the touchpad satisfies an exclusion condition; and
(b) when the event occurred on the touch device or the touchpad satisfies the exclusion condition, ignoring a command triggered by pressing downward the touchpad.

16. The touch device as claimed in claim 15, wherein
the touchpad comprises a pressing module disposed under the touch operation surface and electrically connecting to the control unit; and
before the touch device executes the step (a), a step of determining whether the pressing module is triggered is executed, and when the pressing module is pressed downward, the pressing module is determined as being triggered.

17. The touch device as claimed in claim 16, wherein the pressing module of the touchpad includes a switch disposed under the touch operation surface, and the step of determining whether the pressing module is triggered includes a further step of determining whether the switch is pressed downward, and the pressing module is triggered when the switch is pressed downward.

18. The touch device as claimed in claim 16, wherein the pressing module of the touchpad includes at least one force sensor and a haptic feedback unit disposed under the touch operation surface, and the step of determining whether the pressing module is triggered includes a further step of determining whether a downward force is larger than a threshold, wherein the downward force is determined by a force information detected by the at least one force sensor, and the pressing module is triggered when the downward force is larger than the threshold, and the haptic feedback unit is activated when the pressing module is triggered and the event does not satisfy the exclusion condition.
